(19) United States
(12) Patent Application Publication
(10) Pub. No.: US 2007/0267291 A1
(43) Pub. Date: Nov. 22, 2007

(54) Electrochemical Sensor Comprising Diamond Particles

(76) Inventors: Clive Edward Hall, Nijmegen (NL); Geoffrey Alan Scarsbrook, Berkshire (GB)

Correspondence Address: OBLON, SPIVAK, MCCLELLAND MAIER & NEUSTADT, P.C., 1940 DUKE STREET, ALEXANDRIA, VA, 22314, US

(21) Appl. No.: 10/592,060

(22) PCT Filed: Mar. 9, 2005
(86) PCT No.: PCT/IB05/00591

§ 371 Date: Jan. 22, 2007

(30) Foreign Application Priority Data
Mar. 9, 2004 (ZA) 2004/1908

(51) Int. Cl. G01N 27/26; B05D 5/12

(52) U.S. Cl. 204/412; 204/400; 427/122

(57) ABSTRACT

The invention relates to a sensor comprising a substrate and an electrode formed on the substrate wherein the electrode comprises a binder and a conductive material containing doped diamond particles. The invention extends to methods of producing the sensor.

### BACKGROUND OF THE INVENTION

THIS invention relates to an electrochemical sensor containing diamond particles, and to a method of producing such a sensor.

An electrochemical sensor is a device which transduces the oxidation or reduction of an analyte of interest into an electrical signal that is used to determine the presence and/or concentration of the analyte. The oxidation or reduction takes place at or near to the surface of a working electrode, the potential of which can be controlled relative to that of the reference and/or counter electrode.

For electroactive analytes, the oxidation or reduction may take place directly on the electrode surface. For other analytes the redox reaction can be catalysed using enzymes, antibodies or other suitable catalysts with the signal being transferred via a mediator that acts as an electron transfer mechanism in moving the electron or electrons to or from the working electrode.

The choice of mediator is determined by the electrochemistry of the system and they are chosen to improve the selectivity of the complete sensor system to the analyte of interest.

Low cost electrochemical sensors comprising a substrate with screen printed electrodes thereon are used in a number of medical and laboratory techniques. In known sensors of this kind, the electrodes typically comprise ink (typically made of conducting graphitic carbon powder), an organic binder, the redox catalyst and the mediator. However, the graphitic carbon powders used in such sensors are electrochemically noisy, with high background currents, and can be electrochemically active themselves. This limits both their areas of application and also their sensitivity.

### SUMMARY OF THE INVENTION

According to the invention there is provided a sensor comprising a substrate and an electrode formed on the substrate, the electrode comprising a binder and a conductive material containing doped diamond particles. The bulk electrical conductivity of the electrode in final form is preferably provided substantially by the doped diamond, and more preferably the doped diamond is the only material contributing significantly to this bulk electrode conductivity.

The binder is preferably a non-conductive material with characteristics suitable to permit an admixture of the binder and the diamond particles to be formed or deposited on the substrate by for example using a printing process, preferably by a screen printing process.

For example, the binder may comprise polyvinyl acetate. Other typical binders include ethyl cellulose, cellulose acetate, fluorosilicone, polystyrol, and polyesters.

The non-conducting substrate may be patterned with electrically conducting tracks onto which the electrode or electrodes may be printed, the electrically conducting tracks forming an electrical connection to the electrodes. Preferably the tracks are metal tracks.

The diamond particles are preferably smaller than 100 microns in size, more preferably smaller than 10 microns in size and still more preferably smaller than 1 micron in size.

The diamond material is preferably boron doped, with a boron concentration exceeding 10¹⁹ atoms/cm³, and more preferably between 10¹⁹ and 10²¹ atoms/cm³.

The electrode may contain or be further coated with a redox catalyst or catalysts and/or a mediator or mediators to give the sensor the required sensitivity and specifity for a desired analyte.

The redox catalyst or catalysts and/or mediator or mediators may be admixed with the binder and diamond particles, or may be applied to the electrode after deposition of the electrode on the substrate.

Alternatively, the diamond particles may be treated with the redox catalyst or catalysts and/or a mediator or mediators prior to being mixed with the binder.

The electrode may be non-porous, presenting a largely planar surface, or it may contain significant surface cavities, or it may be porous, the surface exhibiting surface cavities or pores enhancing the available surface area of the electrode able to participate in electrochemistry. In a further variation the electrode is sufficiently porous to enable fluid flow through the electrode.

Further according to the invention there is provided a method of producing a sensor, the method comprising:
admixing a binder and sufficient conductive powder comprising doped diamond particles to form a paste which is electrically conducting when dry or cured;
printing or by other means forming the paste onto a substrate to define one or more electrodes on the surface of the substrate; and
drying or curing the paste.

The paste is preferably applied to the substrate by screen-printing.

Alternatively to provide cavitated or porous electrodes the method may comprise:
admixing a binder, a pore forming agent and sufficient conductive powder comprising doped diamond particles to form a paste which is electrically conducting when dry or cured;
printing or otherwise forming the paste onto a substrate to define one or more electrodes on the surface of the substrate;
drying or curing the binder element of the paste; and
removing the pore forming agent for example by sublimation, preferably at a higher temperature, or by chemical reaction, or by other means.

The doped diamond particles are preferably in a suitable form.

The paste is preferably applied to the substrate by screen-printing.

The method may include adding a redox catalyst or catalysts and/or a mediator or mediator species such as an enzyme, antibody or other chemical selected to react with a predetermined analyte to the admixture.

Alternatively, the method may comprise treating the diamond particles with the redox catalyst or catalysts and/or a mediator or mediators prior to mixing them with the binder.

The invention further provides a sensor comprising a substrate and a plurality of electrodes deposited or otherwise formed on the substrate, the electrodes comprising a binder and a conductive material containing doped diamond particles, wherein the function of a first electrode is differentiated by variation in the composition or fabrication of the electrode compared to a second electrode. In particular, the first electrode may have different sensitivity to different agents or chemicals to be detected when compared to a second electrode and to selected further electrodes if any, and such differentiation may be provided by the use of different catalysts or mediators.

### DESCRIPTION OF EMBODIMENTS

Electrochemical sensors operate by transducing the oxidation or reduction of an analyte of interest into an electrical signal. Such sensors are commonly produced by screen-printing conductive electrodes on a non-conductive substrate. The electrodes frequently comprise a carbon based ink which consists of graphitic carbon powder as a conductive material, an organic binder for physical integrity, a redox catalyst that reacts with the substance being measured to give or take electrons from it and a mediator that transfers the electrons to or from the electrode. The redox catalyst can be an enzyme, antibody, inorganic ion or other chemical substance.

Electrodes formed from a paste with binder and conductive medium can be formed onto a substrate surface by a number of means, including extrusion from a nozzle, screen printing, ejection or ballistic means. In this specification, the preferred solution of screen printing is generally referred to, however those skilled in the art will understand that the means of forming the electrodes can be any of those known in the art and the solution used to form the electrode may be application and geometry dependent.

Some screen-printed electrodes use metal powders and an inorganic binder phase. Electrodes can be printed on a wide range of substrates or carrier materials, the only condition being that the substrate is itself electrically insulating or provided with an insulating coating such that there is no electrical activity between the substrate and the electrode or the electrochemical process. Often, screen printed electrodes are used for bulk, low cost, or disposable applications and as such it is also preferable, although not a technical requirement, that the substrates are relatively inexpensive. Typical substrates include glass, non-conducting plastics, ceramics, and crystalline materials such as materials such as sapphire.

In order to provide a sensor with enhanced electrical and electrochemical properties, this invention discloses electrodes produced utilizing a conductive powder comprising conductive diamond particles that are suitably engineered to be admixed with a binder into a paste or “ink” that can be screen-printed or otherwise deposited on a substrate. Suitable engineering of the diamond grit includes controlling the size and size distribution of the grit, and the type of diamond used in the grit, including single crystal and polycrystalline HPHT synthesized diamond and both polycrystalline and single crystal CVD synthesized diamond. Suitable engineering of the diamond grits also includes the method of forming the grit from the diamond source, the shape and aspect ratio of the grit and how this relates to the crystal morphology, the concentration of boron and other impurities in the diamond, and the surface termination of the diamond. Any combination of these parameters may require further modification in order to best accommodate the type of mediator or catalyst used, if any, the method binding the mediator or catalyst, and method of forming the paste and final method of curing the electrode. The benefits of using diamond grit as the conductive component and active electrode surface include that diamond is very inert, making the electrode more robust, and that the potential window of diamond in electrochemical processes is very wide.

A number of known techniques can be utilized to provide the basic diamond material suitable for the grits used in this invention. For example, diamond material can be produced using a low-pressure chemical vapor deposition (CVD) technique with boron containing species added to the gas phase, to produce a polycrystalline boron doped diamond material on a substrate. Such diamond material is referred to as polycrystalline CVD diamond. Control of the CVD growth process can vary the predominant growth morphology and growth sector, and the manner in which the diamond crushes down to a grit, affecting the final grit shape. The significance of the different growth sectors is discussed later. Under certain growth conditions it is possible to form columnar grains at high growth rates which are not well inter-grown and can be separated by methods such as chemical etching and crushing. Such diamond grits are unusual in that by careful preparation it is possible to form particles with aspect ratios typically exceeding 1.2 and more typically exceeding 1.5 and even more typically exceeding 2.0 and most typically exceeding 3.0. Grits with much larger aspect ratios are also possible. In addition, because of the unique growth direction present in a CVD growth process onto a planar substrate, the internal growth morphology of individual CVD diamond crystallites produced in a polycrystalline diamond layer makes them less susceptible to reducing to equiaxed particle morphologies during crushing. In some instances, fracture during crushing occurs preferably in a plane which contains or lies close to the initial CVD growth direction, retaining or enhancing the higher aspect ratio of the material. Thus CVD polycrystalline diamond can be crushed down to form diamond grits with relatively high aspect ratio and with relatively sharp features.

Alternatively the substrate in a CVD diamond growth process can be a diamond substrate, and the diamond formed by homoepitaxial growth to form single crystal. Single crystal CVD diamond exhibits less spatial variation in properties and crushes down to a more regular grit. Growth sectors, if present tend to be larger and thus tend to dominate individual grit particles formed by this method.

A third form of CVD diamond is heteroepitaxial growth, where the diamond is nucleated in a highly oriented fashion on a lattice matched substrate such as silicon. This latter technique provides diamond with a different predominant growth sector, at least partly selectable by the precise growth process details, and a different shape morphology to polycrystalline diamond, and has distinct characteristics under crushing to form a uniquely shaped grit which has a long aspect ratio, or a squat aspect ratio if the initial layer thickness is lower than the typical inter-nucleation spacing, but a relatively blocky form compared to some forms of polycrystalline diamond.

A fourth method of grit production by CVD techniques is fluidized bed, flow suspended particle, or particle fall growth techniques, which may coat or grow existing smaller particles or which may enable nucleation and growth of grits or powders.

Alternatively, the diamond grits may be produced by HPHT techniques. HPHT synthesis of diamond grits, optionally used in combination with controlled crushing processes, can also be controlled to form a variety of morphologies and different growth sectoral particles. The majority of HPHT synthesized diamond grits are single crystal grit particles, but using suitable process conditions twinned or polycrystalline particles can also be formed and used in this invention.

In order to make diamond behave as an electrical conductor it can be doped with boron, typically at boron concentrations between 10¹⁹ and 10²¹ atoms per cm³ (cc). The specific resistance of diamond at 0.1% (atomic percent) boron concentration is typically 1×10⁻³ Ωm. The uptake of boron by diamond during synthesis is in part dependent on the growth sector of the material. For example, the {111} growth sector generally takes up more boron than the {100} growth sector, by an amount which can exceed a factor of 5 or more but which is itself process dependent. Consequently, the distribution of growth sectors in the final diamond largely affects the distribution of the boron concentration and thus the electrical resistivity. Thus the boron concentrations quoted are those averaged over the volume of the material; the exact method of averaging are dependent on the precise form of diamond considered but the principle is clear and the methods well known in the art.

The lower limit of boron concentration in the diamond suitable for an application may depend on that concentration affecting the precise electrochemistry of interest. More generally the limit is set by the need to provide sufficient conductivity to the completed electrode. Thus in particular, the preferred boron concentration exceeds 1×10¹⁹ atoms/cc, and more preferably exceeds 5×10¹⁹ atoms/cc, and more preferably exceeds 1×10²⁰ atoms/cc, and most preferably exceeds 5×10²⁰ atoms/cc.

The upper limit on the boron concentration is more typically set by the ability to incorporate boron without degrading crystal structure, and by the distribution of the various growth sectors present. Thus an upper limit on the beneficial level of boron in the material is difficult to determine, but a typical practical limit is about 1×10²¹ atoms/cc.

For normal polycrystalline CVD diamond growth, the different growth sectors are very small and the {111} growth sector provides a significant part of the total volume, although the precise fraction can be varied by controlling the texture and the growth conditions. In contrast, in single crystal CVD or HPHT diamond which is then crushed, the individual growth sectors tend to be larger and dominate whole grit particles: In HPHT synthesis, B doped material generally has a {111} habit, so that the majority of material is {111} growth sector, whereas CVD single crystal diamond is more generally grown on a predominantly {100} surface, resulting in predominantly {100} sector growth. Heteroepitaxial CVD diamond growth can form either predominantly {100} or {111} growth, although in the presence of boron {111} growth is more common. In grits used for this invention, it has been found that preferably one or more of the following should apply:
a) preferably at least 30%, and more preferably 40%, and more preferably 50%, and more -preferably at least 60%, and most preferably at least 70% of the volume of the grit used should be {111} growth sector material.
b) Preferably at least 60% and more preferably at least 80% of the diamond grit particles should contain at least some material formed from the {111} growth sector.

As a consequence, HPHT grits, or polycrystalline CVD diamond grits grown under controlled conditions are generally preferred to single crystal CVD diamond grits or to grits formed for other CVD processes encouraging {100} growth sector formation.

In a variation of any of the above processes, boron could be diffused into the diamond powder at high temperature and possibly also at high pressure after manufacture thereof, although this is generally not a preferred method as achieving suitable high levels of B doping can be more difficult.

In order to obtain diamond particles with acceptable inter-particle conduction, the surface of the diamond material is preferably hydrogen terminated, which can be achieved by treatment or manufacture of the diamond material at high temperature in a hydrogen containing atmosphere or by treatment in a hydrogen containing plasma. In other specific applications, particularly in combination with some mediators catalysts, at least a fraction of some other surface termination may be beneficial, for example oxygen termination, and these can be achieved by using other treatments such as immersion in oxidizing agents or oxygen plasma treatment. However it is preferable that the diamond surface is at least predominantly hydrogen terminated. Most preferably, treatments to modify or control surface termination of the diamond grits are applied after the grit has been crushed or otherwise been prepared in the final size distribution.

In addition, the grit needs to be low in nitrogen concentration, primarily because nitrogen compensates boron and reduces the conductivity of the material although it may also have a role in the electrochemical processes. In the preparation of HPHT grits, this generally requires the use of nitrogen getters. In CVD diamond processes the control of nitrogen to the required levels is possible by controlling gas phase concentrations of nitrogen in the source gas. Preferably the boron to nitrogen concentration ratio in the solid should exceed 10, and more preferably 30, and even more preferably 100 and even more preferably 300, and most preferably 1000.

The diamond may be used with the size and shape distribution as synthesized if the synthesis method provides a suitable size and morphology, and such grits are generally fairly regular, blocky, and with low sharpness, with typical regular morphologies including cubic, octahedron and dodecahedron shapes. However the grit is more typically further processed by crushing. A number of methods of crushing are known in the art, and the precise method of crushing is less important than the results obtained. Three shape characteristics of the grit are particularly important; these are the size, the aspect ratio, and the sharpness. These characteristics are generally controlled by a combination of the source material used, the crushing method, and the method of sieving or sorting. After crushing the grit may optionally undergo further processing such as chemical rounding or polishing, and such chemical shape processing may include controlling the surface termination of the diamond

The sorting or separation of ultra-hard grits and the characterization of their characteristic grit size are well known in the art. Typically separation is achieved by sedimentation techniques, although alutriation (similar to sedimentation but using an upwardly flowing liquid medium) or air classification techniques (typically using ballistic properties) are also used. Characterization of the grit size and shape distribution is typically achieved, at the grit sizes in question, by using laser scattering techniques (for example using the MasterSizer series of instruments from Malvern Products, UK).

In terms of size, the key requirement is to provide particles of sufficiently small size and suitable size distribution to create a screen-printable paste when admixed with a suitable non-conductive binder such as polyvinyl acetate, but to form a mechanically stable and conductive electrode on curing. Diamond grits can be prepared in a range of different grit sizes, for example nano-diamond is available in sizes typically in the range 5-100 nm, and may be formed by techniques such as explosion synthesis, laser synthesis and others. Larger sizes include the submicron grits in the range 0.1 μm to 1 μm, and can be prepared by crushing etc. with for example a size spread of 50 nm, and micron size grits covering the range 1 μm-20 μm and larger.

A key parameter in the final cured screen printed electrode is the electrical connectivity between the diamond particles, and thus to a certain extent the volume of space occupied by the diamond. This has to be balanced with retaining sufficient workability in the final paste to enable the screen printing process, and the impact it may have on the integrity of the final cured electrode. A particularly useful method of increasing the total content by volume and/or the electrical connectivity of the diamond grit is the use of bi-modal, tri-modal, or other multi-modal grit size distributions. For example, in a bi-modal grit distribution the interstices between the particles of the larger grit size can be filled substantially with the grit particles with a smaller grit size. In a tri-modal distribution, the smallest grit size particles can fill the remaining interstices. Typically in a tri-modal (or equivalently in a bi-modal) grit distribution, the size of the different grits vary by about a factor of 10, for example comprising 4 μm, 0.4 μm, and 40 nm. Using multi-modal grit distributions it is possible to achieve more than 80% grit content by volume, although this may impact on the mechanical cohesion of the system, or the workability of the paste during printing

The maximum size of the diamond powder particles should be less than 100 microns, preferably less than 10 microns and more preferably less than 1 micron. In a multi-modal grit distribution, this limit relates to the largest grit size used.

More particularly, the electrode, the paste forming the electrode and the diamond grit forming the conductive element of the electrode preferably exhibit one or more of the following characteristics:
1. The paste is capable of forming stable electrodes after curing with a thickness in the range 100 μm to 1 mm, and preferably in the range 200 μm to 500 μm. The thickness of the electrodes after curing is therefore preferably greater than 100 μm and more preferably greater than 200 μm. The thickness is also preferably less than 1 mm thick, more preferably less than 500 μm thick.
2. The electrodes formed after curing contain diamond grit in a total concentration by volume exceeding 30%, and more preferably exceeding 40%, and more preferably exceeding 50%, and more preferably exceeding 60%, and most preferably exceeding 70%;
3. The diamond grit size as characterised by the mean diameter prior to forming the composite is preferably less than 60 μm, more preferably less than 30 μm, even more preferably less than 20 μm, even more preferably less than 15 μm, and most preferably less than 10 μm in size (in a multi-modal grit distribution, this limit relates to the largest grit size used);
4. The diamond grit size as characterized by the mean diameter is preferably greater than 0.1 μm, more preferably greater than 0.2 μm, and most preferably greater than 0.5 μm (in a multi-modal grit distribution, this limit relates to the largest grit size used);
5. The ratio of the grit size as characterized by the mean diameter prior to forming the electrode, to the final thickness of the electrode formed, is preferably less than 0.5, and more preferably is less than 0.2, and most preferably is less than 0.1 (in a multi-modal grit distribution, this limit relates to the largest grit size used);
6. The ratio of the grit size as characterized by the mean diameter prior to forming the composite, to the final thickness of the electrode formed, is preferably greater than 0.001, and more preferably is greater than 0.005, and even more preferably is greater than 0.01, and most preferably is greater than 0.05 (in a multi-modal grit distribution, this limit relates to the largest grit size used);

Once the diamond grit is prepared, including the stage of modifying the surface termination of the diamond where this is used, it may be admixed with a redox catalyst or catalysts and/or a mediator or mediators, together with the binder in order to give the electrode the necessary electrochemical properties, or the diamond powder may be treated directly with the redox catalyst or catalysts and/or a mediator or mediators before being mixed with the binder. The redox catalyst might be an enzyme, an antibody or another chemical substance. By way of example, blood glucose monitors utilize the enzyme glucose oxidase as the redox catalyst and this is combined with the material of a screen-printed electrode to measure blood glucose levels. Those skilled in the art will understand that a very wide range of binders and catalysts are available and appropriate for use under this invention.

The electrodes can be formed by any known means, however, nozzle extrusion and screen printing are preferred methods, with screen printing being the most preferable method. Electrodes can be formed onto simple substrates, or substrates providing electrical interconnection such as by metal tracks, or onto complex substrates which carry active devices for example associated with the interpretation of the response of the electrodes. Electrodes may be used individually, or in groups of similar or dissimilar electrodes, or in groups which jointly provide a single function.

Compared with known screen-printed electrodes comprising graphitic carbon powder, the electrodes of the invention have a number of advantages. Firstly, diamond is chemically inert and insoluble in all solids and gases up to 450° C., so can be used in extreme chemical environments. Diamond is biocompatible and does not provoke a strong response from the body when used in vivo. Diamond also has useful electrochemical properties. In particular, diamond has a very wide potential window in aqueous solution allowing access to electrochemical reactions that would otherwise be masked by water decomposition. Diamond has low electrochemical background noise and has inherently low fouling. The diamond surface can be modified with biochemicals, metals and metal oxides for a sensing or catalytic function. Thus a very wide range of applications can be envisaged for these electrodes, including analysis of gases and gas contaminants, analysis of liquids and liquid contaminants, analysis of wet biological samples, skin based detectors, in vivo detectors, analysis of biological fluids, food analysis, “lab-on-chip” devices, and chemical (metal, organic and inorganic) sensors. A particular utility is in one time or disposable sensors, and in particular those requiring multiple different analyses simultaneously, using a number of different electrodes printed onto a common substrate. In order to enhance the performance of the final electrode, a preferred method of the invention comprises boron doped diamond particles which are engineered according to at least one of size, shape or surface termination in order to enhance the performance of the electrode.

The utility of this invention will be illustrated further by the use of the following non-limiting examples:

### EXAMPLE 1

CVD diamond grit was prepared with a volume averaged boron concentration of 10²⁰ atoms/cc, by a process of CVD polycrystalline diamond synthesis in the presence of diborane gas and then crushing and sieving. The nitrogen concentration in this diamond was measured to be below 0.1 ppm. The crushing/sieving process was used to provide a grit with a nominal grit size of 1.4 μm mean diameter, with a size distribution such that about 90% of the grit by mass exceeded 0.45 μm and 90% of the grit by mass was below 2.7 μm. This grit was then mixed with a polyvinyl acetate binder, with the diamond forming about 45% of the total volume of the electrode after curing. This paste was then formed into electrodes by a number of means including standard screen printing techniques and nozzle deposition were then used to produced. These were then cured and prepared for prepared for immersion into the electrochemical solution.

Tests on the electrical conductivity of the system demonstrated that these were sufficient for purpose, and that the electrochemical response was sufficiently close to that of solid diamond electrodes to provide useful electrochemical function.

### EXAMPLE 2

A number of CVD diamond grits were prepared using a variety of different material sources (homoepitaxial diamond, heteroepitaxial diamond, polycrystalline diamond with controlled texture). In general, in order to obtain boron levels significantly above 10¹⁹ atoms/cc in the diamond it was generally found necessary to use a substantial volume fraction of {111} growth sector in the diamond grit, preferably at least 30% by volume of the diamond. Diamond with less than 10¹⁹ atoms/cc boron was found to provide insufficient electrical conductivity for the majority of electrochemical applications. The behavior of paste containing diamond with close to or just above 10¹⁹ atoms/cc boron was found to be sensitive to a number of other factors. In particular, bi-modal grits with sizes centred at about 2.5 μm and 0.25 μm and a volume ratio of 1:1 of the two components gave better electrical conductivity that monomodal grits, particularly since they allowed higher total volumes of diamond in the final cured electrode. Alternatively, grits with a high aspect ratio or sharp grits had a higher electrical conductivity in the cured electrode. Furthermore, control of the surface termination proved to be very important in these grits with B concentrations near 10¹⁹ atoms/cm³, with hydrogen terminated surfaces (produced by suitable chemical or hydrogen plasma treatment methods) providing a much higher electrode conductivity and more generally fit for purpose than grits with uncontrolled or deliberately oxygen terminated surfaces. Grits with a with a volume averaged boron concentration near 10²⁰ atoms/cc or greater, typically having at least 50% {111} growth sector by volume, were found to be less susceptible to some of these other variables and consequently these higher boron concentrations and {111} growth sector concentrations were preferable.

### EXAMPLE 3

As a counter example, HPHT diamond grit was produced with a volume averaged boron concentration of 10¹⁸ atoms/cc, by adding a boron source to the capsule. In addition, nitrogen getters were used to reduce the nitrogen concentration in the diamond to below 1 ppm. A crushing/sieving process was then used to provide a grit with a nominal grit size of 1.4 μm mean diameter, with a size distribution such that about 90% of the grit by mass exceeded 0.45 μm and 90% of the grit by mass was below 2.7 μm. This grit was then mixed with a polyvinyl acetate binder, with the diamond forming about 45% of the total mixture. This paste was then formed into electrodes by a number of means following the procedures of Example 1.

Tests on the electrical conductivity of the system demonstrated that the electrical conductivity of the electrode was insufficient for electrochemical purposes.

### EXAMPLE 4

The method of example 3 was used, except that the HPHT grit was surface treated by hydrogen plasma means to produce a hydrogen terminated surface. Although the electrical conductivity of the final electrode was improved, the conductivity was generally insufficient for application.

The method of example 3, with and without being followed by hydrogen termination of the diamond surface, was then applied to HPHT grits with volume averaged boron concentrations of 5×10¹⁸ atoms/cc and 1×10¹⁹ atoms/cc.

Without hydrogen surface termination the grit with 5×10¹⁸ atoms/cc boron did not perform adequately, and the grit with 1×10¹⁹ atoms/cc boron performed sufficient for a limited range of applications. Hydrogen surface termination of the grits improved the performance of the electrodes formed from both grits, and in particular made the grit with 1×10¹⁹ atoms/cc boron form electrodes suitable for a much wider range of applications.

1. A sensor comprising a substrate and an electrode formed on the substrate, the electrode comprising a binder and a conductive material containing doped diamond particles

2. A sensor according to claim 1, wherein bulk electrical conductivity of the electrode in final form is provided substantially by the doped diamond.

3. A sensor according to claims 1 or 2, wherein the electrode is deposited on the substrate.

4. A sensor according to any one of claims 1 to 3, wherein the electrode is deposited on the substrate by printing.

5. A sensor according to any one of claims 1 to 4, wherein the electrode is deposited on the substrate by screen printing.

6. A sensor according to any one of claims 1 to 5, wherein the diamond particles are boron doped.

7. A sensor according to claim 6, wherein the diamond particles have a boron concentration exceeding 10¹⁹ atoms/cm³.

8. A sensor according to claim 7, wherein the diamond particles have a boron concentration less than 10²¹ atoms/cm³.

9. A sensor according to any one of claims 1 to 8, wherein the diamond particles are a diamond grit having an average grit size less than 100 μm.

10. A sensor according to claim 9, wherein the average grit size is less than 20 μm.

11. A sensor according to claim 9, wherein the average grit size is less than 10 μm.

12. A sensor according to any one of claims 9 to 11, wherein the average grit size is greater than 0.1 μm.

13. A sensor according to any one of claims 1 to 12, wherein the diamond particles are manufactured by CVD diamond synthesis.

14. A sensor according to claim 13, wherein the CVD diamond process forms polycrystalline diamond layers.

15. A sensor according to any one of claims 1 to 12, wherein the diamond particles are single crystal diamond particles manufactured by HPHT diamond synthesis

16. A sensor according to any one of claims 1 to 15, wherein the size and/or shape of the diamond particles is controlled by crushing and/or sieving.

17. A sensor according to any one of claims 1 to 16, wherein at least 30% by volume of the diamond is formed from the {111} growth sector.

18. A sensor according to any one of claims 1 to 17, wherein at least 60% of the diamond particles contain at least some material formed from the {111} growth sector.

19. A sensor according to any one of claims 1 to 18, wherein the diamond particles are modified for surface termination.

20. A sensor according to claim 19, wherein the surface modification forms a predominantly hydrogen terminated surface.

21. A sensor according to claim 19, wherein the surface is essentially fully hydrogen terminated.

22. A sensor according to any one of claims 1 to 21, wherein the boron concentration of the diamond particles exceeds the nitrogen concentration of the particles by at least a factor of 10.

23. A sensor according to claim 22, wherein the boron concentration of the diamond particles exceeds the nitrogen concentration of the particles by at least a factor of 100.

24. A sensor according to any one of claims 1 to 23, wherein the diamond particles are prepared in a manner suitable to enhance the formulation of high aspect ratio (needle) diamond particles having an aspect ratio exceeding 1.5.

25. A sensor according to any one of claims 1 to 24, wherein the diamond particles are bi-modal or multi-modal.

26. A sensor according to claim 25, wherein the size of the different particles varies by about a factor of 10.

27. A sensor according to any one of claims 1 to 26, wherein the electrode formed on the substrate has a thickness exceeding 0.1 mm.

28. A sensor according to any one of claims 1 to 27, wherein the electrode formed on the substrate has a thickness less than 1 mm.

29. A sensor according to any one of claims 1 to 28, wherein the electrode formed on the substrate contains a diamond concentration by volume exceeding 30%.

30. A sensor according to claim 29, wherein the diamond concentration exceeds 40% by volume.

31. A sensor according to any one of claims 1 to 30, wherein the ratio of the diamond particle size to the thickness of the electrode is greater than 0.001.

32. A sensor according to any one of claims 1 to 31, wherein the ratio of the diamond particle size to the thickness of the electrode is less than 0.5.

33. A sensor according to any one of claims 1 to 32, wherein the substrate is non-conducting.

34. A sensor according to claim 33, wherein the substrate includes electrically conducting tracks onto which the electrode may be formed, the tracks forming an electrical connection to the electrode.

35. A sensor according to any one of claims 1 to 34, wherein the electrode includes a pre-selected redox catalyst and/or mediator to tailor the electrode to a required sensitivity, specificity and/or analyte.

36. A sensor according to claim 35, wherein the catalyst and/or mediator are admixed with the binder and diamond particles.

37. A sensor according to claim 35, wherein the catalyst and/or mediator are applied to the electrode after formation of the electrode on the substrate.

38. A sensor according to claim 35, wherein the diamond particles are treated with the catalyst and/or mediator prior to being mixed with the binder.

39. A sensor according to any one of claims 1 to 38, wherein the electrode is non-porous.

40. A sensor according to claim 39, wherein the electrode presents a largely planar surface.

41. A sensor according to any one of claims 1 to 38, wherein the electrode is porous.

42. A sensor according to claim 41, wherein the electrode presents a surface exhibiting surface cavities or pores enhancing the available surface area of the electrode able to participate in electrochemistry.

43. A sensor according to claim 41, wherein the electrode is sufficiently porous to enable fluid flow through the electrode.

44. A method of producing a sensor, the method comprising the steps of:
admixing a binder and sufficient conductive powder comprising doped diamond particles to form a paste which is electrically conducting when dry or cured;
printing or otherwise forming the paste onto a substrate to define one or more electrodes on the surface of the substrate; and
drying or curing the paste.

45. A method according to claim 44, wherein the paste is applied to the substrate by screen printing.

46. A method according to claim 44 or 45 further including the additional step of including a pore forming agent in the admixture of binder and conductive powder.

47. A method according to claim 46 further including the additional step of removing the pore forming agent by sublimation, by chemical reaction or by other means.

48. A method according to any one of claims 44 to 47 including the additional step of adding a redox catalyst and/or mediator to the admixture.

49. A method according to claim 48, wherein the mediator is an enzyme, antibody or other chemical selected to react with a predetermined analyte.

50. A method according to any one of claims 44 to 47 including the additional step of treating the diamond particles with a catalyst and/or mediator prior to mixing them with the binder.

51. A method according to any one of claims 44 to 45 in which in order to enhance the performance of the final electrode boron doped diamond particles are used which are engineered according to at least one of size, shape or surface termination.

52. A sensor comprising a substrate and a plurality of electrodes deposited or otherwise formed on the substrate, the electrodes comprising a binder and a conductive material containing doped diamond particles wherein a function of a first electrode is differentiated by variation in the composition or fabrication of each the electrode compared to a second electrode.

53. A sensor as claimed in claim 52, wherein a first electrode has a different sensitivity to different analytes as a result of a pre-selected catalyst and/or mediator compared to a second electrode.
